(19) United States
(12) Patent Application Publication
(10) Pub. No.: US 2025/0178527 A1
(43) Pub. Date: Jun. 5, 2025

(54) VEHICLE MANAGEMENT SYSTEM AND BATTERY ELECTRIC VEHICLE

(71) Applicant: TOYOTA JIDOSHA KABUSHIKI KAISHA, Toyota-shi (JP)

(72) Inventors: Takahiro UCHIDA, Kasugai-shi (JP); Seiji ARAKAWA, Nisshin-shi (JP); Kazuhito SAKAI, Mishima-shi (JP); Chie FUKUHARA, Toyota-shi (JP); Yoshikazu HARA, Atsugi-shi (JP)

(73) Assignee: TOYOTA JIDOSHA KABUSHIKI KAISHA, Toyota-shi (JP)

(21) Appl. No.: 18/945,535

(22) Filed: Nov. 13, 2024

(30) Foreign Application Priority Data
Nov. 30, 2023 (JP) 2023-203213

(51) Int. Cl. B60Q 5/00; B60L 50/60; B60R 16/023

(52) U.S. Cl. CPC B60Q 5/005; B60L 50/60; B60R 16/0231; B60L 2240/423; B60L 2240/486; B60L 2240/507; B60L 2250/28; B60Y 2306/11

(57) ABSTRACT

A battery electric vehicle includes one or more processors configured to generate a pseudo engine sound and to output the pseudo engine sound from a speaker mounted on battery electric vehicle. The one or more processors obtain a load weight of battery electric vehicle. The one or more processors then change the pseudo engine sound in response to the load weight.

### CROSS-REFERENCE TO RELATED APPLICATION

This application claims priority to Japanese Patent Application No. 2023-203213 filed on Nov. 30, 2023, incorporated herein by reference in its entirety.

### BACKGROUND

### 1. Technical Field

The present disclosure relates to battery electric vehicles including an electric motor as a driving source.

### 2. Description of Related Art

Conventionally, there has been a technique of making a pseudo engine sound in a battery electric vehicle that is generated when a virtual engine vehicle including an internal combustion engine (engine) as a driving source travels. For example, Japanese Unexamined Patent Application Publication No. 2022-036005 (JP 2022-036005 A) discloses estimating a load to be applied to a virtual engine when the virtual engine is controlled based on driving operations. JP 2022-036005 A also discloses estimating a pseudo engine sound (virtual sound) to be generated in a vehicle cabin when the virtual engine is controlled according to the estimated load. JP 2022-036005 A discloses a control device for a vehicle that includes a controller for controlling an acoustic device to generate the estimated pseudo engine sound.

### SUMMARY

Making a pseudo engine sound in a battery electric vehicle can give a driver a realistic feeling as if he/she were driving an engine vehicle. Moreover, making the pseudo engine sound more realistic contributes to improving satisfaction of the driver who tries to listen to the pseudo engine sound.

Characteristics of an engine sound that is generated in an actual engine vehicle vary depending on the overall weight of the vehicle to be driven by an engine. The overall weight of the vehicle changes depending on the situation when driving is performed due to the number of occupants, the content of the load, etc. Conventionally, it has not been considered to generate a pseudo engine sound that reflects such a change in total weight of the vehicle. One object of the present disclosure is to make a pseudo engine sound more realistic by focusing on a change in overall weight of the vehicle.

A battery electric vehicle including an electric motor as a driving source according to an aspect of the present disclosure includes
one or more processors configured to generate a pseudo engine sound and output the pseudo engine sound from a speaker mounted on the battery electric vehicle.

The one or more processors are configured to
acquire a load weight of the battery electric vehicle, and
change the pseudo engine sound according to the load weight.

According to the present disclosure, the pseudo engine sound that is output from the speaker changes according to the load weight of the battery electric vehicle. This allows to output a more realistic pseudo engine sound.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram illustrating a battery electric vehicle and a vehicle management system according to an embodiment;

FIG. 2 is a block diagram illustrating an example of a functional configuration of a vehicle management system related to a function of outputting a pseudo engine sound;

FIG. 3 is a flowchart illustrating a process flow of a process executed by the vehicle management system with respect to a function of outputting a pseudo engine sound;

FIG. 4 is a block diagram illustrating another example of a functional configuration of a vehicle management system related to a function of outputting a pseudo engine sound;

FIG. 5 is a block-diagram illustrating an exemplary configuration of a power control system of battery electric vehicle; and

FIG. 6 is a conceptual diagram illustrating an example of a change in an output characteristic in accordance with an increase in the load weight.

### DETAILED DESCRIPTION OF EMBODIMENTS

Embodiments of the present disclosure will be described with reference to the accompanying drawings.

### Battery Electric Vehicle and Vehicle Management System

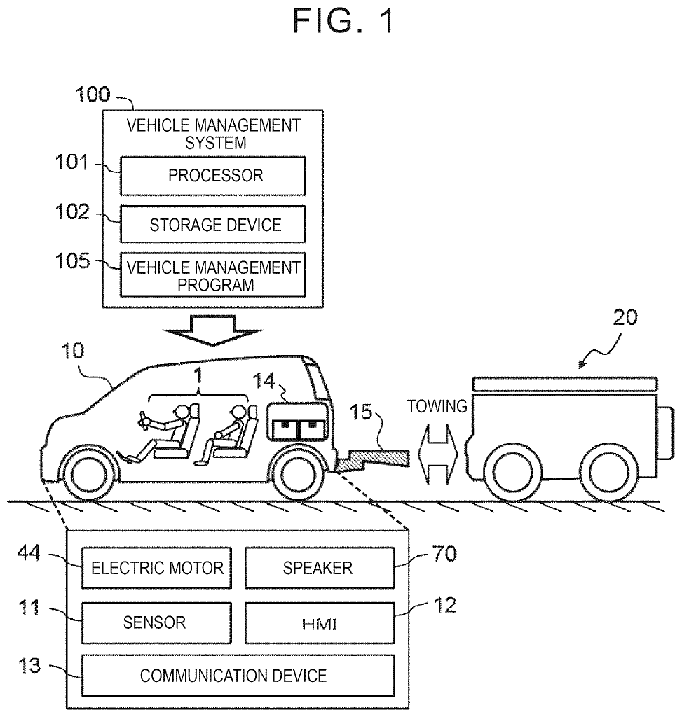

FIG. 1 is a conceptual diagram illustrating a battery electric vehicle 10 and a vehicle management system 100 according to the present embodiment. Battery electric vehicle 10 includes an electric motor 44 as a driving source. Examples of the electric motor 44 include a brushless DC motor and a three-phase AC synchronous motor. Battery electric vehicle 10 uses the electric motor 44 as a driving power device.

Battery electric vehicle 10 includes various sensors 11. The various sensors 11 detect the driving state of battery electric vehicle 10. Examples of the various sensors 11 include an accelerator position sensor, a brake position sensor, a steering angle sensor, a steering torque sensor, a wheel speed sensor, an acceleration sensor, a rotational speed sensor, a position sensor, and an ambient environment recognition sensor. The accelerator position sensor detects an operation amount of the accelerator pedal. The brake position sensor detects an operation amount of the brake pedal. The steering angle sensor detects a steering angle of the steering wheel. The steering torque sensor detects a steering torque of the steering wheel. The wheel speed sensor detects a rotational speed of a wheel of battery electric vehicle 10. The acceleration sensor detects lateral acceleration and longitudinal acceleration of battery electric vehicle 10. The rotational speed sensor detects the rotational speed of the electric motor 44. The position sensor detects the position of battery electric vehicle 10. Examples of the position sensor include a Global Navigation Satellite System (GNSS) sensor. The ambient environment recognition sensor is a sensor for recognizing (detecting) an environment surrounding battery electric vehicle 10. Examples of the ambient-environment-aware sensor include cameras, light detection and ranging (LiDAR), radars, and the like. The driver recognition sensor is a sensor for recognizing (detecting) a driver of battery electric vehicle 10.

In the present embodiment, the various sensors 11 include a weight sensor for detecting the load weight of battery electric vehicle 10. The load weight of battery electric vehicle 10 is the weight increased due to the loading of a human vehicle or an object with respect to the normal vehicle weight of battery electric vehicle 10. For example, the on-vehicle weight includes a weight increased by the weight of the occupant 1 and a weight increased by the load loaded in the luggage compartment 14. That is, the load weight is one parameter representing a change in the weight of the entire vehicle. The weight sensor includes, for example, a weight gauge embedded in a seat or a luggage compartment 14.

Further, battery electric vehicle 10 is equipped with one or more speakers 70. For example, the speaker 70 is an in-vehicle speaker that outputs sound into a vehicle cabin of battery electric vehicle 10. As another example, the speaker 70 may be an outside speaker that outputs sound to the outside of battery electric vehicle 10. Battery electric vehicle 10 may include both an in-vehicle speaker and an out-vehicle speaker.

Battery electric vehicle 10 also includes a human machine interface (HMI) 12 as an interface with the user. HMI 12 presents various types of information to the user by displaying or sounding, and accepts various types of input from the user. HMI 12 includes a display (e.g., a multi-information display, a meter display), a switch, a speakerphone, a touch panel, and the like. The speaker 70 may be configured as a part of HMI 12.

Battery electric vehicle 10 also includes a communication device 13 that communicates with an external device to transmit and receive data. Examples of the communication device 13 include a device that connects to the Internet and transmits and receives information to and from various servers, a device that communicates with infrastructure facilities and transmits and receives infrastructure information, and a device that transmits and receives information to and from surrounding vehicles and transmits and receives other vehicle information.

Further, battery electric vehicle 10 is configured to execute towing of another vehicle (towed vehicle 20) by including the towed vehicle attachment portion 15. Battery electric vehicle 10 may be configured such that the towed vehicle attachment portion 15 is operably provided only when towing is to be executed. For example, the towed vehicle attachment portion 15 may be a component that is manually attached to battery electric vehicle 10 by the user. Alternatively, the towed vehicle attachment portion 15 is normally in a stored state, and may be pulled out when the towing is executed. In this case, the towed vehicle attachment portion 15 may be automatically pulled out in response to a user's request via HMI 12. The structure of the towed vehicle attachment portion 15 is not particularly limited. The towed vehicle 20 may be directly attached, or the towed vehicle 20 may be connected via a lobe or the like. The towed vehicle 20 may also be a vehicle of various forms. For example, the towed vehicle 20 includes other ordinary vehicles that have become stuck due to gas shortage or failure, a trailer for loading a load, a movable battery used as an external battery of a battery electric vehicle 10, and the like.

In this way, battery electric vehicle 10 uses the towed vehicle attachment portion 15 to execute towing of another vehicle (towed vehicle 20). In connection with execution of the towing, in the present embodiment, the various sensors 11 may further include a towing information detection sensor for detecting information on towing (towing information). The towing information detection sensor includes, for example, a weighing scale, a camera, or the like provided in the towed vehicle attachment portion 15. In addition, in the present embodiment, the communication device 13 may include a device that performs inter-vehicle communication with the towed vehicle 20 and acquires towing information. The towing information detection sensor and the communication device 13 acquire, for example, information on whether towing is being executed, a resistance force received by 15 the towed vehicle 20, a weight of the towed vehicle 20, a vehicle type and a type of the towed vehicle 20, an attitude of the towed vehicle 20, and the like.

The vehicle management system 100 is applied to such a battery electric vehicle 10 and manages battery electric vehicle 10. The entire vehicle management system 100 may be mounted on a battery electric vehicle 10. As another example, at least a portion of the vehicle management system 100 may be included in a management server external to battery electric vehicle 10. The vehicle management system 100 may then remotely manage battery electric vehicle 10. As another example, the vehicle management system 100 may be distributed between battery electric vehicle 10 and the management server.

Generally speaking, the vehicle management system 100 includes one or more processors 101 (hereinafter simply referred to as processors 101) and one or more storage devices 102 (hereinafter simply referred to as storage devices 102). The processor 101 executes various processes. The processor 101 includes a general-purpose processor, an application-specific processor, a Central Processing Unit (CPU), a Graphics Processing Unit (GPU), an Application Specific Integrated Circuit (ASIC), a Field-Programmable Gate Array (FPGA), an integrated circuit, a conventional circuit, and the like. The processor 101 may also be referred to as a circuitry or a processing circuitry. Circuitry is hardware programmed to implement the described functions, or hardware that performs the functions. The storage device 102 stores various types of information. Examples of the storage device 102 include volatile memory, non-volatile memory, a hard disk drive (HDD), a solid state drive (SSD), and the like. The functions of the vehicle management system 100 are realized by the cooperation of the processor 101 and the storage device 102.

The one or more vehicle management programs 105 (hereinafter simply referred to as vehicle management programs 105) are computer programs executed by the processor 101. The functions of the vehicle management system 100 may be realized by cooperation of the processor 101 executing the vehicle management program 105 and the storage device 102. The vehicle management program 105 is stored in the storage device 102. Alternatively, the vehicle management program 105 may be recorded in a computer-readable recording medium.

For example, the vehicle management system 100 has a function as a sound management system that manages sounds related to battery electric vehicle 10. In particular, the vehicle management system 100 generates and manages sounds outputted from the speaker 70 mounted on battery electric vehicle 10. In addition, the vehicle management system 100 outputs the generated sound through the speaker 70 mounted on battery electric vehicle 10.

In particular, the vehicle management system 100 generates a “pseudo engine sound” simulating an engine sound of an engine vehicle as a function of the sound management system. Then, the vehicle management system 100 outputs the pseudo engine sound from the speaker 70 mounted on battery electric vehicle 10. The engine vehicle is a vehicle that has an internal combustion engine (engine) and uses the engine as a driving power unit (driving source).

By outputting the pseudo engine sound from the speaker 70 in battery electric vehicle 10 by the vehicle management system 100, it is possible to give the driver a sense of realism as if the driver is driving the engine vehicle. Further, by making the pseudo engine sound more realistic, it is possible to expect an improvement in satisfaction of the driver. Incidentally, the characteristics of the engine sound generated in an actual engine vehicle differ depending on the weight of the entire vehicle to be driven by the engine. This is because as the weight of the entire vehicle increases, the torque required to drive the entire vehicle increases.

The vehicle management system 100 according to the present embodiment can output a more realistic pseudo engine sound by focusing on a change in overall weight of the vehicle. Hereinafter, the vehicle management system 100 according to the present embodiment will be described in detail with respect to a function as a sound management system that outputs a pseudo engine sound. Output of Pseudo Engine Sound

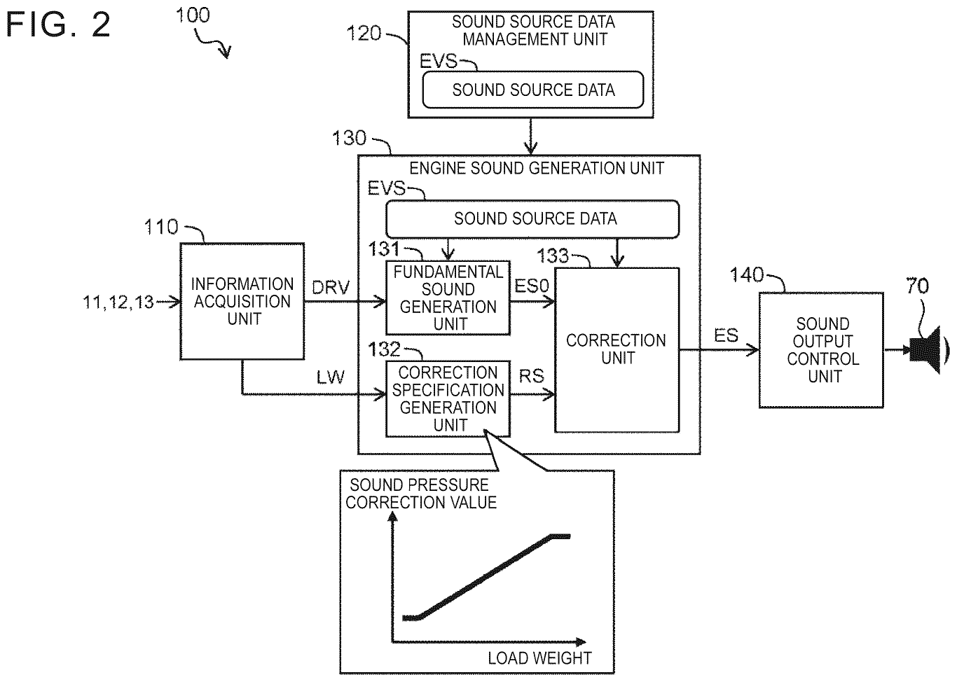

FIG. 2 is a block diagram illustrating an example of a functional configuration of the vehicle management system 100 related to a function of outputting a pseudo engine sound. The vehicle management system 100 includes an information acquisition unit 110, a sound source data management unit 120, an engine sound generation unit 130, and a sound output control unit 140 as functional blocks. These functional blocks are realized, for example, by cooperation of the processor 101 executing the vehicle management program 105 and the storage device 102.

The information acquisition unit 110 acquires various types of information related to battery electric vehicle 10. For example, the information acquisition unit 110 acquires information detected by the various sensors 11 mounted on battery electric vehicle 10. Further, for example, the information acquisition unit 110 acquires information inputted by the drivers via HMI12. Further, for example, the information acquisition unit 110 acquires information received by the communication device 13.

In particular, the information acquisition unit 110 acquires the driving state information DRV indicating the driving state of battery electric vehicle 10. The driving state information DRV includes information related to driving operations by drivers, information related to traveling states of battery electric vehicle 10, information related to conditions around battery electric vehicle 10, and the like. For example, the driving state information DRV includes the operation amount of the accelerator pedal (accelerator operation amount), the operation amount of the brake pedal (brake operation amount), the steering angle, steering speed, steering tightening, wheel speed, wheel speed, vehicle speed, before and after acceleration, horizontal acceleration, the revolving speed of the electric motor 44, and the like. The driving state information DRV includes a virtual engine rotational speed Ne. Here, it is assumed that battery electric vehicle 10 uses the virtual engine as a driving power unit (driving source). The virtual engine rotational speed Ne is a rotational speed of the virtual engine when battery electric vehicle 10 is assumed to be driven by the virtual engine. For example, the information acquisition unit 110 may calculate the virtual engine rotational speed Ne so as to increase as the wheel speed increases. When battery electric vehicle 10 includes a manual mode (MT mode), which will be described later, the information acquisition unit 110 may calculate the virtual engine rotational speed Ne in the manual mode based on the wheel speed, the overall reduction ratio, and the slip ratio of the virtual clutch. The method of calculating the virtual engine rotational speed Ne in the manual mode will be described later.

In particular, the information acquisition unit 110 acquires information on the load weight LW of battery electric vehicle 10. The information acquisition unit 110 can acquire information on the load weight LW from the weight sensor.

The sound source data management unit 120 stores and manages the sound source data EVS used for generating the pseudo engine sound. In particular, the sound source data management unit 120 may store and manage a plurality of sound source data EVS (EVS-A, EVS-B, EVS-C, . . . ) corresponding to a plurality of vehicle types (A, B, C, . . . ). That is, the sound source data management unit 120 may store and manage the sound source data EVS for each vehicle type. The sound source data EVS is typically composed of a plurality of types of sound source data. The plurality of types of sound source data include, for example, sound source data of sound caused by engine combustion (for low-speed, medium-speed, and high-speed), sound source data of sound caused by a drive system such as a gear (for low-speed, medium-speed, and high-speed), sound source data of noise sound, and sound source data of event sound (e.g., gargle sound and engine stall sound). Each sound source data is generated in advance through a simulation based on an engine model and a vehicle model of the engine vehicle, or the like. Each sound source data is configured to be capable of flexibly adjusting at least one of a sound pressure and a frequency of a sound.

The engine sound generation unit 130 (engine sound simulator) is a simulator that generates a pseudo engine sound. The engine sound generation unit 130 reads the sound source data EVS from the sound source data management unit 120. When the sound source data management unit 120 stores and manages the sound source data EVS for each vehicle type, the engine sound generation unit 130 selects and reads one of the plurality of sound source data EVS. At this time, the engine sound generation unit 130 may be configured to select and read the sound source data EVS corresponding to the vehicle type designated by the drivers among the plurality of vehicle types. The drivers can specify the vehicle type via HMI 12. The engine sound generation unit 130 generates a pseudo engine sound by combining one or more sound source data included in the sound source data EVS.

The engine sound generation unit 130 includes a basic sound generation unit 131, a correction specification generation unit 132, and a correction unit 133. The engine sound generation unit 130 acquires the driving state information DRV and battery electric vehicle 10 the load weight LW from the information acquisition unit 110.

The basic sound generation unit 131 generates the basic pseudo engine sound ES0 according to battery electric vehicle 10 driving state (virtual engine rotational speed Ne or vehicle speed) based on the driving state information DRV. The method of generating the basic pseudo engine sound ES0 is not particularly limited in the present embodiment. For example, the basic sound generation unit 131 may be configured to generate the basic pseudo engine sound ES0 by a well-known engine simulator employed in gaming or the like. Further, for example, the basic sound generation unit 131 may generate the basic pseudo engine sound ES0 by increasing or decreasing the frequency in proportion to the virtual engine rotational speed Ne and increasing or decreasing the sound pressure in proportion to the virtual engine torque according to the map of the virtual engine rotational speed Ne-frequency and the map of the virtual engine torque-sound pressure. The basic pseudo engine sound ES0 generated by the basic sound generation unit 131 is transmitted to the correction unit 133.

The correction specification generation unit 132 generates a specification (correction specification RS) for correction of the basic pseudo engine sound ES0 to be executed by the correction unit 133, which will be described later. The correction specification RS indicates, for example, a correction value of a sound pressure, a correction value of a frequency, a correction of a tone color, a sound source data to be added, and the like. In particular, in the present embodiment, the correction specification generation unit 132 generates the correction specification RS based on at least battery electric vehicle 10 load weight LW. The correction specification RS generated at this time reproduces a change in the engine noise caused by a change in the weight of the entire vehicle in the actual engine vehicle. Typically, the correction specification generation unit 132 generates the correction specification RS so as to increase the sound pressure correction value as the load weight LW increases. This reproduces an increase in the sound pressure of the engine sound due to an increase in torque required to drive the entire vehicle. The correction specification generation unit 132 can determine the sound pressure correction value for the load weight LW by using the map of the load weight LW-sound pressure correction value, and generate the correction specification RS. FIG. 2 illustrates an exemplary map of the load weight LW-sound pressure corrections. In addition, the correction specification generation unit 132 may generate the correction specification RS by determining the sound source data to be added in order to reproduce the change in the engine sound in the actual engine vehicle in accordance with the load weight LW. The sound source data to be added may be included in the sound source data EVS read by the engine sound generation unit 130. For example, the sound source data EVS may include a plurality of sound source data recorded for each loaded weight when the loaded weight is changed in the corresponding actual engine vehicle. The correction specification RS generated by the correction specification generation unit 132 is transmitted to the correction unit 133.

The correction unit 133 corrects the basic pseudo engine sound ES0 in accordance with the correction specification RS. For example, the correction unit 133 corrects the sound pressure of the basic pseudo engine sound ES0 in accordance with the sound pressure correction value indicated by the correction specification RS. Further, for example, the correction unit 133 adds the sound source data indicated by the correction specification RS to the basic pseudo engine sound ES0.

The pseudo engine sound generated by the engine sound generation unit 130 is the basic pseudo engine sound corrected by the correction unit 133. The engine sound generation unit 130 outputs an engine sound data ES that is a day indicating the pseudo engine sound. Incidentally, as described above, the correction specification RS is generated based on at least battery electric vehicle 10 load weight LW. Therefore, the pseudo engine sound generated by the engine sound generation unit 130 reflects the information of the load weight LW. Typically, the sound pressure of the pseudo engine sound generated by the engine sound generation unit 130 increases as the load weight LW increases.

The sound output control unit 140 receives the engine sound data ES generated by the engine sound generation unit 130. Then, the sound output control unit 140 outputs the pseudo engine sound through the speaker 70 based on the engine sound data ES.

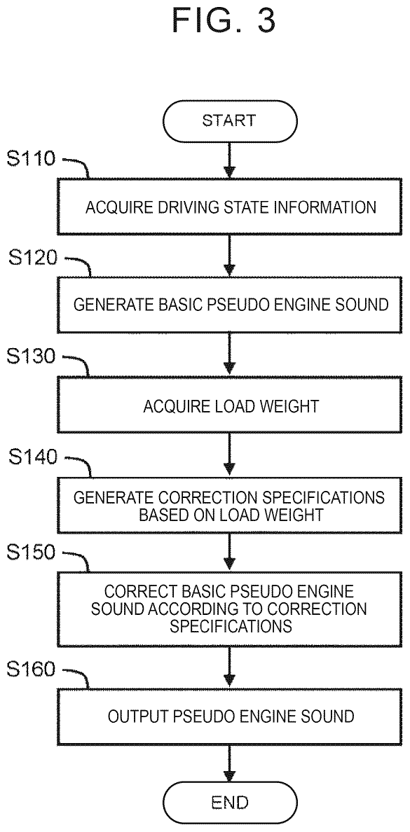

FIG. 3 is a flowchart illustrating an example of a process flow of a process executed by the vehicle management system 100 regarding a function of outputting a pseudo engine sound based on the above-described functional configuration. The processing flow illustrated in FIG. 3 is repeatedly executed at a predetermined processing cycle.

First, in S110, the vehicle management system 100 acquires the driving state information DRV.

Next, in S120, the vehicle management system 100 generates the basic pseudo engine sound ES0 corresponding to the driving state of battery electric vehicle 10 based on the driving state information DRV.

Next, in S130, the vehicle management system 100 acquires battery electric vehicle 10 load weight LW.

Next, in S140, the vehicle management system 100 generates a correction specification RS based at least on the load weight LW.

Next, in S150, the vehicle management system 100 generates a pseudo engine sound by correcting the basic pseudo engine sound ES0 in accordance with the correction specification RS.

Then, in S160, the vehicle management system 100 outputs the generated basic pseudo engine sound from the speaker 70.

As described above, the vehicle management system 100 according to the present embodiment is configured. According to the vehicle management system 100 of the present embodiment, the pseudo engine sound outputted from the speaker 70 changes in accordance with the load weight LW of the battery electric vehicle 10. The load weight LW is one parameter representing a change in weight of the entire vehicle. Therefore, the pseudo engine sound can reproduce a change in the engine sound due to a change in the weight of the entire vehicle in the actual engine vehicle. In this way, the vehicle management system 100 according to the present embodiment can output a more realistic pseudo engine sound. As a result, it is expected to improve the satisfaction of the driver.

### Sound Management in Consideration of the Execution Status of Towing

Battery electric vehicle 10 according to the present embodiment is configured to execute towing of another vehicle (towed vehicle 20). When battery electric vehicle 10 executes towing, the weight of the entire vehicle that the driving source is going to drive is increased by the weight of the towed vehicle 20. As a result, the torque required to drive the entire vehicle increases. Therefore, when assuming an actual engine vehicle, it is conceivable that the characteristics of the pseudo engine sound change when the towing is executed. On the other hand, the weight of the towed vehicle 20 does not appear in the load weight LW. Therefore, the vehicle management system 100 according to the present embodiment can be configured to generate a pseudo engine sound that is output from the speaker 70 in consideration of the execution status of the towing.

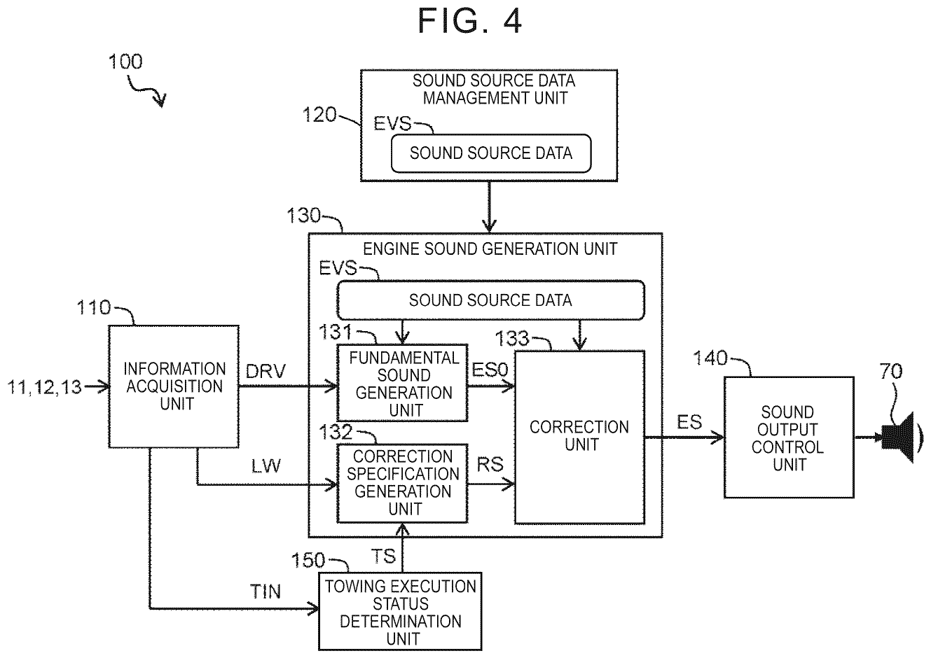

FIG. 4 is a block diagram illustrating an example of a functional configuration of the vehicle management system 100 in a case where the execution status of the towing is taken into consideration. In the example illustrated in FIG. 4, in addition to the functional blocks described in FIG. 3, a towing execution status determination unit 150 is further included. This functional block is realized, for example, by cooperation of the processor 101 and the storage device 102.

The towing execution status determination unit 150 acquires information on towing (towing information TIN) via the information acquisition unit 110. Then, the towing execution status determination unit 150 determines the execution status of the towing (towing execution status TS) based on the towing information TIN. The towing execution status TS includes at least information on whether battery electric vehicle 10 is executing towing. The towing execution status TS may further include the weight of the towed vehicle 20. In addition, the towing execution status TS may include information such as a resistance force received by the towed vehicle 20, a type and a type of the towed vehicle 20, and an attitude of the towed vehicle 20. The towing execution status determination unit 150 transmits the towing execution status TS to the correction specification generation unit 132.

Upon receiving the towing execution status TS, the correction specification generation unit 132 generates the correction specification RS based on the towing execution status TS in addition to the load weight LW. The correction specification generation unit 132 generates the correction specification RS so as to increase the sound pressure correction value at least when the battery electric vehicle 10 executes towing. This makes it possible to reproduce an increase in the sound pressure of the engine sound due to an increase in the torque required for driving the entire vehicle by the towed vehicle 20. Further, the correction specification generation unit 132 may generate the correction specification RS so as to increase the sound pressure correction value as the weight of the towed vehicle 20 increases. Alternatively, the correction specification generation unit 132 may generate the correction specification RS by determining the sound pressure correction value according to the vehicle type and the type of the towed vehicle. In this case, the sound pressure correction value is determined, for example, from the specifications of the vehicle type and the weight of the type.

The correction specification generation unit 132 may separately generate the correction specification RS based on the load weight LW and the correction specification RS based on the towing execution status TS, or may collectively generate each of them. For example, when battery electric vehicle 10 performs towing, the correction specification generation unit 132 may determine the sound pressure correction value in accordance with the sum of the load weight LW and the weight of the towed vehicle 20, and generate the correction specification RS.

The other functional blocks are the same as the functions described with reference to FIG. 2.

By providing the functional configuration of the vehicle management system 100 as described above, the pseudo engine sound output from the speaker 70 reflects the execution status of the towing. Typically, when battery electric vehicle 10 is performing towing, the sound pressure of the pseudo engine sound increases. In this manner, the vehicle management system 100 may be configured to output a more realistic pseudo engine sound in connection with the execution of the towing.

### Applications to Battery Electric Vehicle with Manual Mode (MT Mode)

An electric motor used as a driving power device in a typical battery electric vehicle differs greatly from an internal combustion engine used as a driving power device in Conventional Vehicle (CV). Due to differences in the torque-characteristics of the power plant, CV requires a transmission, whereas battery electric vehicle generally does not include a transmission. Of course, a typical battery electric vehicle does not include a manual transmission (MT) that switches the gear ratio by manual operation of a driver. Therefore, there is a large difference in driving sensation between driving of a manual transmission vehicle (hereinafter, referred to as a MT vehicle) and driving of a battery electric vehicle.

On the other hand, the electric motor can relatively easily control the torque by controlling the applied voltage and field. Therefore, in the electric motor, it is possible to obtain a desired torque characteristic within the operating range of the electric motor by performing appropriate control. By taking advantage of this characteristic, the torque of battery electric vehicle can be controlled to simulate the torque characteristic peculiar to MT vehicles. In addition, a pseudo shifter imitating a transmission member used to perform a shifting operation of a MT vehicle may be provided in battery electric vehicle so that the driver can obtain a driving feeling such as a MT vehicle. As a result, MT vehicles can be simulated in battery electric vehicle.

In other words, battery electric vehicle controls the power of the electric motor so as to simulate MT vehicle-specific operating characteristics (torque-characteristics). The driver performs a pseudo manual shifting operation by operating a pseudo shifter. Responsive to the simulated manual shifting operation by the drivers, battery electric vehicle simulates MT vehicles and changes the operating characteristics (torque characteristics). This allows the drivers of battery electric vehicle to feel as if they are driving MT vehicles. The control mode of the electric motor for simulating the driving characteristic of MT vehicles and the manual shifting operation is hereinafter referred to as a “manual mode” or a “MT mode”.

The disclosed battery electric vehicle 10 may include such a manual mode (MT mode). In MT mode, battery electric vehicle 10 generates a pseudo engine sound corresponding to the driving operation of the driver, and outputs the pseudo engine sound from the speaker 70. Since not only driving maneuvers of MT vehicles but also engine sounds of MT vehicles are replicated, satisfaction of a driver seeking reality is increased.

Hereinafter, an exemplary configuration of a battery electric vehicle 10 including a manual mode (MT mode) will be described.

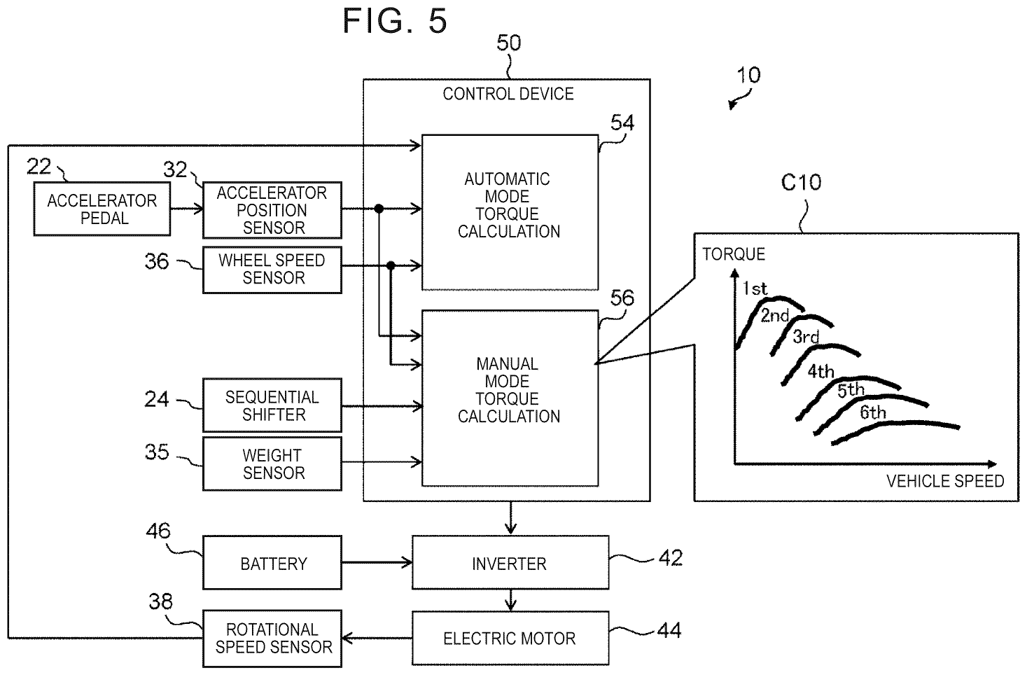

FIG. 5 is a diagram illustrating an exemplary configuration of a power control system of battery electric vehicle 10 according to the present embodiment. The battery 46 stores electrical energy that drives the electric motor 44. That is, battery electric vehicle 10 is a battery electric vehicle (BEV) that runs on electric energy stored in the battery 46. The inverter 42 converts DC power input from the battery 46 into drive power of the electric motor 44 at the time of acceleration. In addition, the inverter 42 converts the regenerative power input from the electric motor 44 into DC power at the time of deceleration, and charges the battery 46.

Battery electric vehicle 10 includes an accelerator pedal 22 for the driver to enter an acceleration demand for battery electric vehicle 10. The accelerator pedal 22 is provided with an accelerator position sensor 32 for detecting an accelerator operation amount.

Battery electric vehicle 10 includes a sequential shifter 24. The sequential shifter 24 is a pseudo shifter imitating a shifter provided in an original MT vehicle. The sequential shifter 24 may be a paddle-type pseudo shifter or a lever-type pseudo shifter.

In the case of a paddle type pseudo shifter, the sequential shifter 24 includes an upshift switch and a downshift switch for determining the operating position. The upshift switch is pulled forward to emit an upshift signal, and the downshift switch is pulled forward to emit a downshift signal.

On the other hand, in the case of a lever-type pseudo shifter, the sequential shifter 24 is configured to output an upshift signal by tilting the shift lever forward, and output a downshift signal by tilting the shift lever backward.

The wheel of battery electric vehicle 10 is provided with a wheel speed sensor 36. The wheel speed sensor 36 is used as a vehicle speed sensor for detecting the vehicle speed of battery electric vehicle 10. Further, the electric motor 44 is provided with a rotation speed sensor 38 for detecting the rotation speed thereof.

Battery electric vehicle 10 includes a control device 50. The control device 50 is typically an electronic control unit (ECU) mounted on a battery electric vehicle 10. The control device 50 may be a combination of a plurality of ECU.

The control device 50 controls the electric motor 44 by PWM control of the inverter 42. The control device 50 processes various input signals and calculates the motor torque command value for PWM control of the inverter 42.

The control device 50 includes an automated mode (EV mode) and a manual mode (MT mode) as control modes. The automatic mode is programmed to continuously change the output of the electric motor 44 in response to operation of the accelerator pedal 22. On the other hand, the manual mode is a control mode for driving battery electric vehicle 10 like MT vehicles. The manual mode is programmed to vary the output characteristics of the electric motor 44 for operation of the accelerator pedal 22 in response to upshift and downshift operations on the sequential shifter 24.

The control device 50 includes an automatic mode torque calculation unit 54 and a manual mode torque calculation unit 56. The units 54 and 56 may be independent ECU or ECU functions obtained by executing programs stored in memories on a processor.

The automatic mode torque calculation unit 54 has the function of calculating the motor torque when the electric motor 44 is controlled in the automatic mode.

The automatic mode torque calculation unit 54 stores a motor torque command map. The motor torque command map is a map for determining the motor torque from the accelerator operation amount and the rotational speed of the electric motor 44. A signal of the accelerator position sensor 32 and a signal of the rotation speed sensor 38 are input to each parameter of the motor torque command map. The motor torque corresponding to these signals is output from the motor torque command map. Therefore, in the automatic mode, even if the driver operates the sequential shifter 24, the operation is not reflected in the motor torque.

The manual mode torque calculation unit 56 includes a MT vehicle-model. MT vehicle model is a model for calculating the drive wheel torque that would be obtained by operating the accelerator pedal 22 and the sequential shifter 24 assuming that battery electric vehicle 10 is a MT vehicle.

MT vehicle model includes an engine model, a clutch model, and a transmission model. The engine model calculates a virtual engine rotational speed and a virtual engine output torque. The virtual engine rotational speed is calculated from the wheel speed, the overall reduction ratio, and the slip ratio of the virtual clutch. The virtual engine output torque is calculated from the virtual engine rotational speed and the accelerator operation amount. In the calculation of the virtual engine output torque, a map that defines the relationship between the accelerator operation amount, the virtual engine rotational speed, and the virtual engine output torque is used.

The clutch model calculates a torque transmission gain. The torque transmission gain is a gain for calculating the torque transmission degree of the virtual clutch according to the virtual clutch opening degree. In the calculation of the torque transmission gain, a map defining a relationship between the virtual clutch opening degree and the torque transmission gain is used.

The clutch model calculates the clutch output torque by using the torque transmission gain. The clutch output torque is a torque output from the virtual clutch. Further, the clutch model calculates a slip ratio. The slip rate is used to calculate the virtual engine speed in the engine model. The slip ratio can be calculated using a map in which the slip ratio is given to the virtual clutch opening degree in the same manner as the torque transmission gain.

The transmission model calculates the gear ratio (transmission ratio). The gear ratio is a gear ratio determined by the virtual gear stage in the virtual transmission. In the calculation of the gear ratio, a map that defines the relationship between the gear ratio and the virtual gear stage is used. The transmission model calculates the transmission output torque using the gear ratio and the clutch output torque obtained from the map. The transmission output torque varies discontinuously in response to the change of the gear ratio. This discontinuous change in the transmission output torque causes a shift shock, which produces a vehicle design with a stepped transmission.

In MT vehicle model, the drive wheel torque is calculated from the transmission output torque calculated by the transmission model using a predetermined reduction ratio. For example, the drive wheel torque is given by the product of the transmission output torque and the reduction ratio.

The control device 50 converts the drive wheel torque calculated by MT vehicle-model into a required motor torque. The required motor torque is a motor torque required to realize the drive wheel torque calculated by MT vehicle model. The reduction ratio from the output shaft of the electric motor 44 to the drive wheels is used to convert the drive wheel torque to the required motor torque. Then, the control device 50 controls the electric motor 44 via the control of the inverter 42 according to the required motor torque.

In this way, the control device 50 performs torque control of the electric motor 44 in the manual mode. As described above, in the manual mode, the motor torque output by the electric motor 44 changes in response to the operation states of the accelerator pedal 22 and the sequential shifter 24 (pseudo shifter). FIG. 5 shows an exemplary output characteristic C10 of the electric motor 44 implemented in manual mode. In the manual mode, an output characteristic C10 can be realized which simulates the torque-characteristics of MT vehicles according to the virtual gear stage (1st, 2nd, . . . , 6th) set by the sequential shifter 24.

In the above-described configuration example, a case has been described in which the pseudo shifter is configured by the sequential shifter 24. As the configuration of the pseudo shifter, another configuration that is assumed in actual MT vehicles may be adopted. For example, the pseudo shifter may include a pseudo shift lever and a pseudo clutch pedal. For example, the pseudo shift lever is provided with positions corresponding to gear stages of 1 gear, 2 gear, 3 gear, 4 gear, 5 gear, reverse, and neutral. The pseudo clutch pedal is operated when the pseudo shift lever is operated. Also in such a configuration, the control device 50 can control the electric motor 44 in each of the automatic mode and the manual mode in the same manner as described above. However, in such a configuration, in the manual mode, the control device 50 determines the virtual gear stage by the shift position of the pseudo shift lever.

### Torque Control Considering Load Weight

As described above, when the control device 50 performs torque control of the electric motor 44 in the manual mode, the drivers of battery electric vehicle 10 can operate battery electric vehicle 10 with torque properties as if driving MT vehicles. Incidentally, in an actual MT vehicle, when the weight of the entire vehicle increases, the torque required to drive the entire vehicle increases. Therefore, when the load weight increases, the driver may feel that the driving force is not as expected. This causes a decrease in the satisfaction of the driver in the manual mode.

Therefore, the control device 50 may be configured to change the output characteristic C10 of the electric motor 44 to be realized in accordance with the load weight LW of battery electric vehicle 10 loaded in the manual mode.

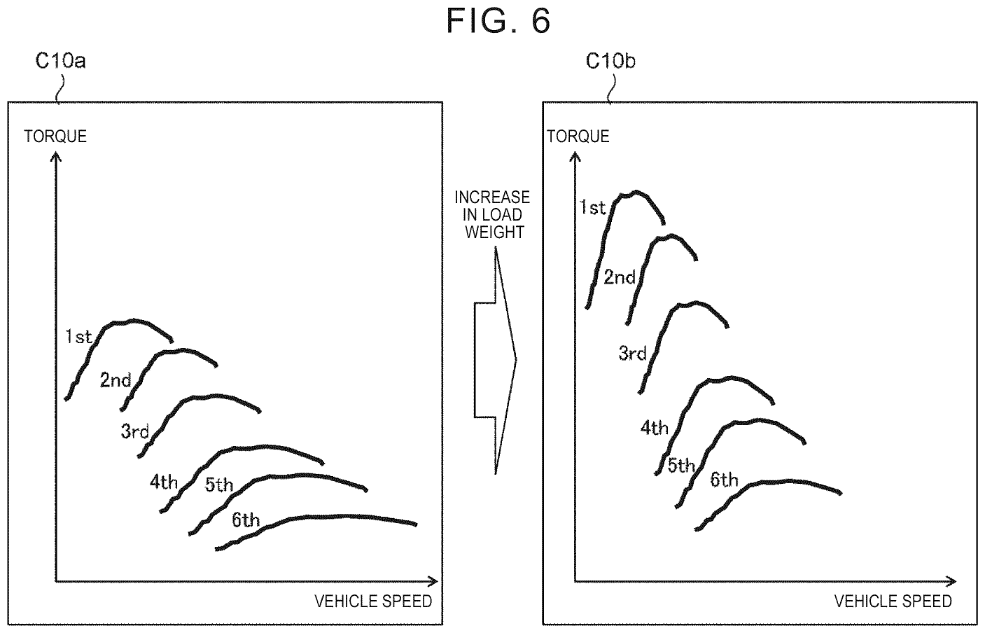

See FIG. 5. The manual mode torque calculation unit 56 of the control device 50 receives battery electric vehicle 10 load weight LW from the weight sensor 35. The manual mode torque calculation unit 56 changes the output characteristic C10 of the electric motor 44 in accordance with the load weight LW. Typically, the output characteristic C10 is changed so that the motor torque with respect to the vehicle speed (motor rotational speed) is increased in the low-speed range as the load weight LW is increased. FIG. 6 is a conceptual diagram illustrating an exemplary change in the output characteristic C10 when the load weight LW is increased. As shown in FIG. 6, when the load weight LW is increased, the output characteristic C10b has a characteristic that a higher motor torque can be obtained in the low-speed range compared to the output characteristic C10a prior to the load weight LW being increased. It should be noted that the change in the output characteristic C10 in accordance with the increase in LW of loaded weights may be performed stepwise or continuously.

In this way, it is possible to suppress the driver's feeling of insufficient driving force when the load weight LW increases by changing the output characteristic C10 according to the load weight LW in the manual mode. Drivers can also enjoy driving with torque that can be covered from the low speed range to the high speed range when the load weight LW is low. In this way, the degree of satisfaction of the driver can be improved.

What is claimed is:

1. A battery electric vehicle including an electric motor as a driving source, the battery electric vehicle comprising one or more processors configured to generate a pseudo engine sound and output the pseudo engine sound from a speaker mounted on the battery electric vehicle, wherein the one or more processors are configured to
acquire a load weight of the battery electric vehicle, and
change the pseudo engine sound according to the load weight.

2. The battery electric vehicle according to claim 1, wherein the one or more processors are configured to increase a sound pressure of the pseudo engine sound as the load weight increases.

3. The battery electric vehicle according to claim 1, wherein:
the battery electric vehicle is configured to execute towing of another vehicle; and
the one or more processors is configured to
determine an execution status of the towing by the battery electric vehicle, and
when the battery electric vehicle is executing the towing, increase a sound pressure of the pseudo engine sound.

4. The battery electric vehicle according to claim 1, further comprising:
an accelerator pedal;
a pseudo shifter imitating an operation member that is used to perform a shifting operation of a manual transmission vehicle; and
a control device configured to perform torque control for controlling motor torque that is output from the electric motor, wherein the torque control includes a manual mode in which the motor torque is changed in response to operation states of the accelerator pedal and the pseudo shifter.

5. The battery electric vehicle according to claim 4, wherein the control device is configured to, when in the manual mode, change an output characteristic of the electric motor in such a manner that the motor torque increases in a low speed range as the load weight increases.
